(19) United States
(12) Patent Application Publication
(10) Pub. No.: US 2019/0382293 A1
(43) Pub. Date: Dec. 19, 2019

(54) Lab Neutralizer System

(71) Applicant: Michael Lloyd, Mequon, WI (US)

(72) Inventor: Michael Lloyd, Mequon, WI (US)

(21) Appl. No.: 16/443,763

(22) Filed: Jun. 17, 2019

Related U.S. Application Data
(60) Provisional application No. 62/686,311, filed on Jun. 18, 2018.

(51) Int. Cl. C02F 1/66; C02F 1/00; G05D 21/02

(52) U.S. Cl. CPC C02F 1/66; C02F 1/008; C02F 2209/003; C02F 2301/08; C02F 2209/06; G05D 21/02

(57) ABSTRACT

A system and method for pH neutralizing waste liquid is provided. The waste liquid to be treated is collected in a treatment tank, and the initial pH of the waste liquid is determined. The initial pH value of the waste liquid is then compared to high and low reference pH values which are the highest and lowest acceptable pH values for the waste liquid after treatment. In accordance with the comparison of the initial pH value of the waste liquid to be treated and the reference pH values, either an acid neutralizer or a base neutralizer is added to the waste liquid using one or more venturis as the waste liquid is being pumped from the treatment tank through a recirculation line until the desired end pH value of the treated waste liquid is equal to or between the reference high and low pH values. After treatment with an acid or base, the treated waste liquid may be discharged from the treatment tank to a drain, sewer, or other destination.

### BACKGROUND OF THE INVENTION

The present invention relates to a system for treating waste liquids, and more particularly to a pH neutralization system for pH neutralizing waste liquids prior to their disposal.

Environmental concerns have resulted in stringent regulations that require manufacturers, health care providers, testing labs, and other users of various chemicals to monitor and control the content and quality of waste liquids, such as waste water or other effluent, resulting from their operations. One area of particular concern for regulators has been the discharge of waste liquids from such laboratories, health care, and other facilities that have a pH that is significantly less than or significantly greater than neutral. Animal testing laboratories and health care laboratories are two areas where regulations increasingly require the pH neutralization of waste liquid which results from washing operations performed on cages, laboratory equipment and medical devices.

The discharge of highly acidic or highly alkaline waste liquids into a sewer system can negatively impact the sewage treatment process, and can also negatively impact plants and animals living in or near streams, rivers, and lakes since many plants and animals are sensitive to the pH level of the water and cannot survive if the pH of the water varies significantly from its natural level. As a result, government regulations typically require that any waste liquid be essentially pH neutral prior to its disposal into a sewer system or directly into the environment. Thus, the pH of waste liquids must be adjusted from either an acidic condition, i.e. a pH of 1-6, or a basic condition, i.e. a pH of 8-14, to a relatively neutral pH condition of about 7, i.e. a pH of 6.5-7.5.

There is thus a need for a waste liquid pH neutralization system that is accurate, and easy to operate, control and monitor.

### SUMMARY OF THE INVENTION

A system and method for pH neutralizing of waste liquids is provided. The waste liquid is collected, and an initial pH of the waste water or effluent is determined. The initial pH value of the waste liquid is compared to high and low reference pH values, i.e. the highest acceptable pH value and the lowest acceptable pH value desired for the treated waste liquid. In accordance with the comparison of the initial pH value of the waste liquid and the reference pH values, either an acid neutralizer or a base neutralizer is added to the waste liquid until the desired end pH value of the treated waste liquid is between the desired high and low reference pH values.

The present system provides an automatic and easily controllable system for effectively adjusting the pH of waste liquid so that the final end pH of the treated waste liquid is within an acceptable range prior to discharge into a drain, sewer or other destination.

Successful pH adjustment of waste liquids is complicated by the non-linear nature of pH neutralization. It is well known that as the measured pH of a liquid nears a neutral pH of 7.0, the effect of small incremental additions of an acid or a base to the liquid is magnified so it becomes relatively easy to overshoot the target pH. The present system anticipates this effect, and thus allows the final end pH of the waste liquid to be accurately controlled and monitored.

### BRIEF DESCRIPTION OF THE DRAWINGS

FIG. 1 is a schematic view of the pH neutralization system in accordance with the present invention.

### DETAILED DESCRIPTION OF THE INVENTION

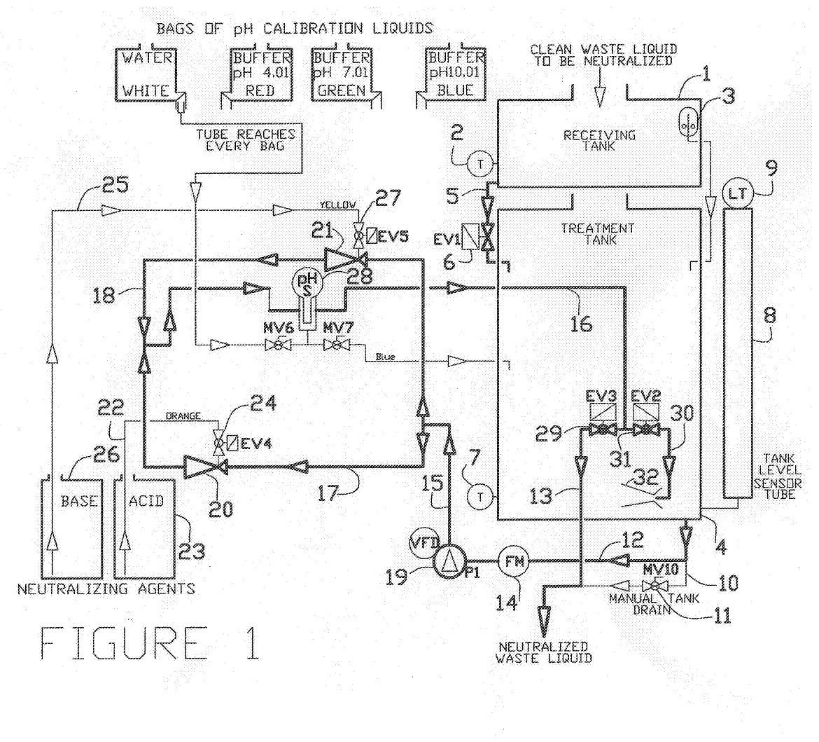

Referring now to FIG. 1, the system and method will now be described.

Waste liquid to be neutralized is first manually poured into a receiving tank 1. Tank 1 is typically composed of stainless steel, and has a capacity of about 35 gallons. Tank 1 is equipped with a thermometer 2 which records the temperature of the waste liquid in tank 1, and a siphon 3 which prevents overfilling of tank 1 by directing any excess waste liquid via gravity to treatment tank 4.

If there are no issues with chemical compatibility or excessive temperature of the waste liquid in tank 1, the waste liquid will flow by gravity via inlet line 5 into the top of tank 4 upon the opening of electric valve 6. Tank 4 is also typically composed of stainless steel, and has a capacity of about 70 gallons. Tank 4 is equipped with a thermometer 7 which records the temperature of the waste liquid in tank 4, and a tank level sensor tube 8 which senses and records the level of the waste liquid in tank 4. Tube 8 includes a level transmitter 9 which generates signals indicative of a desired high level and a desired low level for the waste liquid in tank 4. Transmitter 9 allows for automatic starting of a treatment sequence when the treatment tank 4 fills to the desired high level and trips it's high level switch, and automatic ending of a treatment sequence when the tank 4 empties to a level which trips it's low level switch. Tank 4 also is equipped with a drain line 10which can be opened or closed by manual valve 11. Drain line 10 is connected between an outlet line 12 leading from the bottom of tank 4, and a discharge line 13 leading to a drain, sewer or other destination. Outlet line 12 has an in-line electronic flow meter 14 for displaying the flow rate of liquid in line 12. Outlet line 12 is a component of a waste liquid recirculation loop for the stacked tank neutralizer schematically illustrated in FIG. 1.

More specifically, the waste liquid recirculation loop includes not only outlet line 12, but also a waste liquid recirculation line comprised of an upstream section 15, a downstream section 16, and two parallel midstream sections, namely, an acid addition section or line 17 and a base addition section or line 18. A pump 19 has it's inlet connected to tank outlet line 12 and it's outlet connected to the upstream section 15 of the waste liquid recirculation line. Pump 14 functions to mix the contents in treatment tank 4, to activate one or more venturis to add neutralizing agents in the midstream sections 17 and 18 of the recirculation line, and to discharge successfully treated waste liquid via line 13, as will hereinafter be described. In order to accomplish these functions, pump 19 includes a variable speed controller such as a variable frequency drive (VFD).

Outlet flow of waste liquid from pump 19 in the upstream section 15 of the recirculation line is split into two parallel streams, namely, the acid addition line 17 and the base addition line 18. Acid addition line 17 has an in-line venture 20 disposed therein, and base addition line 18 has an in-line venture 21 disposed therein. Each venture 20 and 21 functions in a conventional manner to produce vacuum sufficient to draw or feed an amount or dose of a pH adjustment chemical into it's respective line 17 or 18. In order to accomplish the addition of a reagent capable of decreasing the pH of waste liquid flowing through venture 20, referred to herein as an acid neutralizing agent or a base neutralizer, the vacuum port of venturi 20 is connected via line 22 to a source 23 of an acid reagent. An in-line electric valve 24 used to open or close line 22. In order to accomplish the addition of a reagent capable of increasing the pH of waste liquid flowing through venture 21, referred to herein as a base neutralizing agent or an acid neutralizer, the vacuum port of venturi 21 is connected via line 25 to a source 26 of a base reagent. An in-line electric valve 27 used to open or close line 25.

As shown in FIG. 1, acid addition line 17 and base addition line 18 recombine downstream of venturis 20 and 21 to form section 16 of the recirculation line. A pH sensor 28 is disposed in section 16 of the recirculation line for sensing the pH of the waste liquid as it flows through section 16 of the recirculation line. Downstream of pH sensor 28, section 16 of the recirculation line splits into the discharge line 13 and a recycle line 30 leading to tank 4. Discharge line 13 may be opened or closed by an electric valve 29 to allow discharge of treated and pH neutralized waste liquid to a sewer, drain or other destination. The flow path through discharge line 13 is used if the pH of the waste liquid meets the treatment standard required by the liquid destination, e.g. a sewer. Typically, the end pH for successfully treated and neutralized waste liquid would be about 6.0 to about 8.0. Recycle line 30 may be opened or closed by an electric valve 31 to allow flow of liquid to treatment tank 4 through a tank mixing venture 32. The flow path through recycle line 30 is used if the pH of the waste liquid does not meet the treatment standard required by the liquid destination, e.g. a sewer. Typically, this would mean that the waste liquid has a pH below 6.0 or above 8.0.

In operation, the initial step is to determine the initial or starting ph of the waste liquid contents in tank 4. To accomplish this initial step, electric valve 6 is opened to allow waste liquid to flow from receiving tank 1 via gravity through line 5 into treatment tank 4. When the waste liquid in treatment tank 4 reaches the desired high level and trips the high level switch of transmitter 9, valve 6 is closed and prevents further inflow of waste liquid into tank 4. After valve 6 closes, the pump 19 starts and begins running at full speed. Waste liquid thus flows from tank 4 through outlet line 12 to the upstream section 15 of the recirculation line, and then through acid addition line 17, base addition line 18, and the downstream section 16 of the recirculation line, and finally through recycle line 30 back into tank 4. At this time, valves 24, 27 and 29 are all closed which allows for the recirculation of waste liquid from tank 4 back to tank 4 resulting in the mixing of waste liquid in tank 4. While waste liquid is being recirculated and being mixed in tank 4, sensor 28 continuously senses and monitors the pH of the waste liquid flowing through downstream section 16. When sensor 28 reports a constant pH value, the measured constant pH value, which now comprises the initial pH value of the waste liquid in tank 4, the measured constant pH value is compared to a high reference pH value and a low reference pH value, which reference pH values are indicative of the highest and lowest acceptable pH values for the destination of the waste liquid to be treated. For example, a common acceptable range is from a low pH of 6.0 to a high pH of 8.0.

Thus, after comparing the initial constant pH value of the waste liquid with the high and low reference pH values, if the initial constant pH value of the liquid waste is equal to or between the high and low reference pH values, e.g. equal to or between 6.0 and 8.0, the flow of waste liquid through the recirculation line is stopped by closing valve 31 of recycle line 30, and opening valve 29 of discharge line 13. This action results in pump 19 discharging the waste liquid from tank 4 via line 13 to a drain, sewer or other destination without requiring any treatment, or pH adjustment, for the waste liquid.

Alternately, however, if the initial constant pH value of the waste liquid is above the high reference pH value, the system adds metered amounts or doses of a base neutralizer, i.e. an acid, to the waste liquid in the recirculation line until the pH value of the waste liquid flowing through the recirculation line is equal to or below the high reference pH value resulting in a pH neutralized waste liquid. This is accomplished by opening valve 24 of venturi 20 to permit an acid neutralizing agent from source 23 to be added to the waste liquid being pumped through line 17 due to the vacuum created by venturi 20. The system monitors and stores the threshold pump motor speed (Hz) needed to draw the acid into line 17 and obtain a change in pH reported by sensor 28. Once a change in pH value has been reported by sensor 28, valve 24 is closed and the speed of pump 19 is increased to mix the waste liquid in tank 4 until a new slightly lower constant pH value is reported by sensor 28. The system then calculates the number of times such an incremental change in pH will be required in order to bring the pH of the waste liquid into compliance below the high reference pH value.

If that calculated number is reasonable, for example less than 10, the system repeats the steps of opening valve 24 of venturi 20, running the pump 19 at the previously stored threshold motor speed, sensing another incremental change in pH by the pH sensor 28, then closing valve 24 when the incremental change in pH is reported by sensor 28, and running pump 19 to mix the waste liquid in tank 4 until a new slightly lower constant pH value is reported by sensor 28. The system will repeat the above steps until sensor 28 reports a constant pH value that is at or below the high reference pH value. At that time, valve 31 of recycle line 30 is closed and valve 29 of discharge line 13 is opened which results in pH neutralized waste liquid being pumped to a drain, sewer or other liquid destination. As an example, if the initial constant pH value of the waste liquid is 10.0 and the high reference pH value is set at 9.0, and the sensed incremental change in pH is 0.2, the system will cycle through the above steps five times before discharging the pH neutralized waste liquid through line 13.

If, however, that calculated number is too great, for example greater than 10 times, the system increases the speed of pump 19 above the threshold motor speed so as to create faster flow which will draw a larger amount or dose of acid from source 23 into line 17 via venturi 20, and then repeats the determination of the number of required pH incremental changes necessary at that increased pump speed. When the number of incremental pH changes required to bring the pH of the waste liquid into the acceptable range drops below 10, the system continues performing the same timed cycle and pH injection recirculation sequences previously described without further increasing the pump speed until the sensor 28 detects a pH that is within an acceptable range. At that time, valve 29 can be opened and valve 31 can be closed to discharge the treated waste liquid from tank 4 via line 13 to a drain, sewer or other liquid destination without requiring any further treatment, or pH adjustment, of the waste liquid.

Alternately, if the initial constant pH value of the waste liquid is below the low reference pH value, the system adds metered amounts or doses of an acid neutralizer, i.e. a base, to the waste liquid in the recirculation line until the pH value of the waste liquid flowing through the recirculation line is equal to or above the low reference pH value resulting in a pH neutralized waste liquid. This is accomplished by opening valve 27 of venturi 21 to permit a base neutralizing agent from source 26 to be added to the waste liquid being pumped through line 18 due to the vacuum created by venturi 21. The system monitors and stores the threshold pump motor speed (Hz) needed to draw the base into line 18 and obtain a change in pH reported by sensor 28. Once a change in pH value has been reported by sensor 28, valve 27 is closed and the speed of pump 19 is increased to mix the waste liquid in tank 4 until a new slightly higher constant pH value is reported by sensor 28. The system then calculates the number of times such an incremental change in pH will be required in order to bring the pH of the waste liquid into compliance above the low reference pH value.

If that calculated number is reasonable, for example less than 10, the system repeats the steps of opening valve 27 of venturi 21, running the pump 19 at the previously stored threshold motor speed, sensing another incremental change in pH by the pH sensor 28, then closing valve 27 when the incremental change in pH is reported by sensor 28, and running pump 19 to mix the waste liquid in tank 4 until a new slightly higher constant pH value is reported by sensor 28. The system will repeat the above steps until sensor 28 reports a constant pH value that is at or above the low reference pH value. At that time, valve 31 of recycle line 30 is closed and valve 29 of discharge line 13 is opened which results in pH neutralized waste liquid being pumped to a drain, sewer or other liquid destination. As an example, if the initial constant pH value of the waste liquid is 5.0 and the low reference pH value is set at 6.0, and the sensed incremental change in pH is 0.2, the system will cycle through the above steps five times before discharging the pH neutralized waste liquid through line 13.

If, however, that calculated number is too great, for example greater than 10 times, the system increases the speed of pump 19 above the threshold motor speed so as to create faster flow which will draw a larger amount or dose of base from source 26 into line 18 via venturi 21, and then repeats the determination of the number of required pH incremental changes necessary at that increased pump speed. When the number of incremental pH changes required to bring the pH of the waste liquid into the acceptable range drops below 10, the system continues performing the same timed cycle and pH injection recirculation sequences previously described without further increasing the pump speed until the sensor 28 detects a pH that is within an acceptable range. At that time, valve 29 can be opened and valve 31 can be closed to discharge the treated waste liquid from tank 4 via line 13 to a drain, sewer or other liquid destination without requiring any further treatment, or pH adjustment, of the waste liquid.

In an alternate embodiment, one or more additional in-line venturis and associated electric valves may be added to lines 17 and 18 of the recirculation line to allow for the addition of auxiliary reagents to the waste liquid. For example, one or more additional venturis may be added to parallel sections 17 and 18 to feed a sterilizing agent to kill infectious organisms or to feed a chemical to suppress undesirable treatment side effects such as foam generation or solids precipitation. In another alternative embodiment, a single in-line venturi having its injection port supplied by two or more sources of neutralizing agents could be used in the recirculation line instead of separate venturis each supplied by its own independent source of neutralizing agent, as described previously herein. Further, although the acid and base neutralizing agents are described herein as being liquids, neutralization may also be accomplished by using treatment gas instead of treatment liquids. For example, carbon dioxide gas can be used to control pH.

The following is a summary of the instructions that an operator of this batch pH neutralization system might need to read and understand about this system, its components and its operation prior to beginning a treatment cycle.

### Neutralizer-Basic System Description

This system is configured as an automated 2-tank neutralizer.
The 35 gallon upper tank manually receives the liquid to be neutralized.
The 70 gallon lower tank is configured as a computer-controlled batch neutralizer.
The computer type is a Programmable Logic Controller referred to in this document as the PLC.
Automated neutralization and liquid transfer operations take place completely under PLC control.
The system also has a manual operating mode. In this mode a trained operator can take direct control of all individual devices.
Even when the trained operator takes manual control of the system, the manual operations are conducted via the PLC.
The upper tank is a passive device. The upper tank has no automatic operations. Its only task is to act as the holding tank for discarded waste liquids pending treatment.
The automated neutralizing program controls lower tank operations only so that all neutralization takes place in the lower tank.
Valve EV1, which allows or prevents flow from the upper tank to the lower tank, is the only automated device that has any involvement with the upper tank. However, even EV1 is controlled by the lower tank's control system.
The system requires two 120 Vac electric circuits to operate.
One circuit is required for the control system.
A second circuit is required to power the pump speed controller (the VFD—Variable Frequency Drive).
Control power and VFD power must both be ON continuously while neutralization is underway. If VFD power goes away for whatever reason, the neutralizer will turn off.
Liquid to be treated is added to the upper tank by personnel who are qualified to perform the task.
Initially, a small amount of the waste liquid to be neutralized is added to the upper tank.
The operator should confirm that nothing unusual happens with that small amount, i.e. no unusual temperature spike or chemical reactions.
If space is available, more waste liquid should then be added to the upper tank.
The system is not designed to empty the tanks completely after each run.
Both tanks will have liquid in them from previous operations.

### Neutralizer Devices

The automatic and manual process control devices provided for this neutralizer are as follows:
1. Process Logic Controller: Horner Electric OCS with color touch screen
2. Pump: Corrosion-resistant mag drive centrifugal adapted for neutralizer service by installing improved elastomer parts.
   60 Hz=3550 rpm
3. Pump motor speed control: Lenze AC Tech VFD
4. Auto Valves: EV1 Lower tank inlet valve
   EV2 Lower tank recirculate valve
   EV3 Treated liquid outlet valve
   EV4 Acid feed valve
   EV5 Base feed valve
5. Manual Valves: MV6 Calibration liquid supply valve
   MV7 Calibration liquid drain valve
6. Lower tank level sensor: LS1
7. pH Probe/Sensor: ChemIndustrial Part 12-583-Probe-Flat

### Neutralizer Operations

1. When system is OFF (or when power is lost) all valves close and the pump is inoperative.
2. When the system is powered ON and the waste liquid level in the lower tank is below the high level setting of level sensor LS1, the system will wait with valve EV1 open, so that more liquid can flow by gravity from the upper tank.
3. If there are no issues with chemical compatibility or excessive temperature, the liquid can be manually poured into the upper tank.
4. The liquid will flow from the upper tank into the lower tank, by gravity, via valve EV1.
5. Level sensor LS1 is located on top of the stand pipe adjacent to the lower tank. LS1 continuously measures liquid level in the stand pipe. The PLC compares that level to the tank high level limit.
6. The Tank Full high limit is factory-set. Because of overflow concerns, this limit is defined within system software, where adjustment is intended to be inaccessible to system users. Furthermore, the output signal range of level sensor LS1 is fixed and thus immune to incorrect adjustment. In addition, level sensor LS1 is fastened securely to the stand pipe to discourage moving it.
7. When the lower tank level reaches tank high level, valve EV1 closes. Valve EV1 will remain closed for the duration of the neutralizing cycle.
8. When liquid reaches high level limit, the neutralizer automatically starts to run.
9. Valve EV1 stays closed until the lower tank level drops below the low level setting of level sensor LS1 at which time the neutralizer stops and the operating cycle returns to the beginning of the Main Automatic Neutralizing Operation page.
10. While the system continues to be powered and all necessary fluids are available, this Main Automatic Neutralizing Operation repeats endlessly.
11. Do not reposition level sensor LS1 up or down because it will provide the system with false level information and, quite likely lead to a stand-pipe or lower tank overflow.

### Neutralizer Operations—Starting And Stopping The System

When power is turned on, the control system goes through a 30 second startup procedure. At this point, the system is not active.

Press the Next button:
This will take you to the REACTIONS WARNING screen.

The REACTIONS WARNING screen provides essential info about system limitations.
Read the information and press the ACCEPT button to go to the MAIN screen (Screen 2).
Users should think of the MAIN screen as the System Operations Center.

Press the RUN PROCESS button:
This will bring you to the on screen Neutralizer Control Panel (Screen 17).
This is where Neutralizer START and STOP buttons are located.

When START is pressed once:
The system clears all run-specific information related to previous operations.
If liquid level in the lower tank is at high level, the system will start the neutralizing sequence.
Otherwise EV1 will open and the system will wait to start a run when the lower tank reaches high level.
Unless some human action or system action interferes, the system endlessly follows the standard neutralizing sequence: Wait, Neutralize, Discharge, and Repeat.

When START is pressed twice within 10 seconds:
Same as when START is pressed once except: the system starts treatment immediately, without waiting for high level.
The end of the current treatment sequence, and all future operations follow the standard sequence.
Pressing the START button a second time after 10 seconds has no effect.

The STOP button:
Stops any neutralization that's underway and prevents any new neutralization operation from starting.
Closes EV1 and prevents it from re-opening.

### Neutralizer Operations—How to Run the Programmed Control System

To run the system in automatic, the operator should select the RUN PROCESS key which will display a RUN screen that provides a live view of the complete process:
   Valves open/closed
   Tank level
   pH
   VFD running frequency (0-60 Hz)
   5-minute pH graph
   The system's only Start and Stop buttons

To start any automatic neutralization operation from this screen:
Press the Start button once
   The system becomes active.
   EV1 is open, allowing liquid to run from the upper tank into the lower tank.
   The system waits for High Level in the lower tank.
   If level is already at (or above) the high limit, the system starts neutralizing

Once the system starts, the system follows the Standard Operating Sequence which always begins when the lower tank reaches high level and ends when the pH has been corrected and liquid pump-out reaches low level.
Immediate Start: If the Start button is pressed a second time within 10 seconds: the system will start treatment immediately, without waiting for high level.
This immediate start feature is in effect for only one treatment batch. After pump-out, the system stays active and will wait for high level before starting to treat the next batch.

Stopping and restarting pH treatment:
Press the Stop button. The system inactivates immediately. The pump stops. All valves close.
If a Neutralizer run was underway everything about that run is forgotten.
Press the Start button once (or twice) to re-start in the same way as described earlier in this section.

### Neutralizer Operating Sequence: The System Discovers what's in this Batch

Step 1: The system is idle, waiting until the liquid batch in the lower tank reaches High Level. Valve EV1 is open, allowing liquid to flow from the upper tank into the lower tank. Step 1 ends when liquid in the lower tank reaches high level.
Step2: The PLC closes valve EV1 to prevent more liquid flow into the lower tank. The PLC pauses 10 seconds, and then advances to Step 3.
Step 3: The PLC opens Valve EV2 to establish the pumping route needed to allow recirculation of the lower tank. The PLC pauses 10 seconds, and then advances to Step 4.
Step 4: The PLC starts the pump and increases its speed. When pump speed reaches 60 Hz, the PLC advances to Step 5.
Step 5: The PLC confirms presence of the flowmeter flow signal. The system alarms if there's no flow signal. If the flow signal is present, the PLC advances to Step 6.
Step 6: The PLC mixes the tank at 60 Hz. After 2 minutes the PLC advances to Step 7.
Step 7: The PLC tests the flowing liquid to confirm tank contents are completely mixed. The test for complete mixing is to compare successive pH measurements taken 30 seconds apart. As long as the pH measurement keeps changing in the same direction, mixing is not complete. When the tank is fully-mixed the PLC advances to Step 8.
Step 8: The pump stops and the PLC displays the mixed liquid's measured pH value.

If the pH value is within the allowed pH discharge range:
Jump to Step 40 which is the start of the tank pump-out sequence

If the pH value is outside the allowed pH discharge range:
Jump to Step 20which is the start of the treatment sequence

Steps 9 through 19 are reserved in case changes are needed to this Discover What's In This Batch sequence.

### Neutralizer Operations: Treat This Batch

Step 20. The PLC opens Acid Feed Valve EV4 or opens Base Feed Valve EV5. The PLC waits 10 seconds and then advances to step 21.
Step 21. The PLC starts the pump VFD and increases the pump speed slowly (1 Hz per second). At some point (at about 35 Hz), pump flow reaches the rate where the venturi becomes active and generates enough vacuum to start sucking acid or base through the open feed valve into the flowing liquid.
The pH probe detects the pH change. The PLC stores the VFD speed when the pH change occurs and advances to Step 22.
Step 22. The PLC closes whichever chemical feed valve was open: Either the Acid Feed Valve EV4 or Base Feed Valve EV5. The PLC remembers which valve and advances to step 23.
Step 23. The PLC increases the VFD speed to 60 Hz for 2 minutes to mix lower tank contents and advances to Step 24.
Step 24. The PLC reduces the VFD motor speed to the value from step 13.
Measure pH and compare it to the pH from step 21 and advance to Step 25.
Step 25. Is the pH within discharge range? Yes: Go to Step 40. No: Go to Step 26.
Step 26. Based on the change in the pH reading, calculate the number of neutralizing events needed to reach the discharge threshold. If the number of events is small (<=10), just do it by repeating steps 22 to 26 as required. If more than 10 events go to Step 27.
Step 27. If the number of calculated events is larger than 10, increase the VFD speed used in step 22 by 1 Hz and repeat steps 21 to step 26. If the concentration of waste liquid in the lower tank is high, it may take multiple passes through steps 21 to 26 to correct pH.
Steps 28 through 39 are reserved in case changes are needed to this Treat This Batch sequence.

### Neutralizer Operations: Discharge The Neutralized Batch

Step 40. Begin to make the batch discharge record.
Step 41. Pump out at Pump out Hz rate (separately set to match sewer capacity).
Step 42. Pump until the neutralizing tank level reaches LS1 Low
Step 43. Stop
Step 44. Update memory card with data from the current run.
   Date, time, volume, pH

### Neutralizer Operations: Manual Operations

The PLC Run screen is used to control the starting and stopping of automatic neutralizer operations. The Run screen has a companion Manual screen that allows most devices to be operated manually.

The Manual screen provides the means for a person who is familiar with the system to perform all allowable system operations. This capability may be useful for training operators and (perhaps) for helping with recovery from unexpected system problems. The only way to reach the PLC Manual screen is from the PLC Run screen. Press the screen's Manual button. This action closes all Automatic valves, stops the pump, then opens the PLC Manual screen.

At this point the PLC Manual screen will be active, but the whole liquid handling system will be inactive with all valves closed and the pump motor at 0 Hz.

The PLC Manual screen displays and allows operation of the pump and valves. It also displays lower tank level, pH probe data, pump speed, pump flow rate and pH probe value.

The system will automatically prevent several errors:
It prevents Lower tank overflow: Valve EV1 will always close if the lower tank is at or above high level.
It protects against pump-seal heat buildup: A time-out function limits the amount of time the pump can operate while lower tank level is below the low level switch.
Prevent pump dead-heading: The pump will not run if both EV1 and EV2 are closed.
Prevent chemical waste: Valves EV4 and EV5 cannot be open at the same time.
Don't let the operator leave with the system running: The Start button provides only 1 minute of inattention. After 1 minute the run display flashes for 15 seconds. Press the Run button within the 15 seconds. Otherwise, the pump will stop and all valves will close. The system can still be restarted

The only way to leave the Manual screen is to return to the Run screen by pressing the Run button on the Manual screen.

### Neutralizer Operations: Calibrating the pH Probe

Measuring pH:
The pH probe is ChemIndustrial's part number: 12-583-Probe-Flat.
The probe utilizes conventional electrochemical technology.
The raw pH probe signal is digitized for presentation to the PLC by ChemIndustrial part number 12-583-Probe-Flat.
The probe housing also contains an RTD which allows process temperature measurement. This measurement is currently used only to display and record temperature information.

The pH probe:
The pH probe is located in a low volume, fully-drainable cavity.
The probe can be calibrated in-place without removing it from its sensing position.
The probe's shape and in-line configuration requires only a small volume of calibration liquid—typically about 60 ml.
Calibration liquids and rinse water are added manually to the pipe-mounted calibration liquid supply vessel.
The probe cavity is easily filled, drained, and flushed by means of two push button actuated valves, namely, valve EV6 (the probe cavity supply valve) and valve EV7 (the probe cavity drain valve).

PLC calibration:
The neutralizer must be stopped before EV6 or EV7 are allowed to operate.
Valve EV2 will be open.
The system allows the probe to be calibrated for three pH values: 4.01, 7.01, and 10.01.
Each calibration point is separate from the others, so it is possible to calibrate one point or two points or all three points.
The system automatically recognizes which calibration standard is present at the probe.

Manual pH probe calibration:
1. Supplies needed:
   a. Calibration standards
   b. RO rinse water
2. Switch to the pH Probe Calibration Screen. Leaving the RUN screen automatically stops the neutralizer.
3. Press the MV7 push button for 15 seconds to drain the probe cavity.
4. Fill the small container attached to EV6 with RO water.
5. Press the MV6 push button for 15 seconds to flush the probe cavity.
6. Open MV7 for 15 seconds to drain the flush water.
7. Add 60 ml of buffer to the small container.
8. Open MV7 so as to fill the probe cavity with the whole quantity of buffer.
9. Watch the Current pH probe value on the PLC screen until the number stops changing.
10. Drag the screen's current calibration value onto the working calibration value.

Optional automated calibration:
If the fully automatic system is installed, the following system features will be present.
The 4 liquids are provided by 4 refillable bags that are located above the neutralizer on supports similar to intravenous fluid bag hooks.
Each refillable bag has a dry-disconnect outlet valve.
The flexible cavity supply tube to MV6 has a fitting that mates with every refillable bag outlet.
The system provides 4 automatic valves plus the required software.

1. A method for pH neutralizing waste liquid, comprising:
(a) collecting waste liquid to be treated in a treatment tank;
(b) pumping the waste liquid to be treated from said treatment tank, through a recirculation line, and back to said treatment tank to mix the waste liquid in said treatment tank;
(c) determining an initial pH value for the waste liquid to be treated in said treatment tank;
(d) comparing the initial pH value of the waste liquid to be treated with a desired acceptable high reference pH value and a desired acceptable low reference pH value for the waste liquid to be treated; and
(e) performing one of the following actions:
(e1) discharging the waste liquid from said treatment tank if the initial pH value of the waste liquid is equal to or between the acceptable high and low reference pH values; or
(e2) adding either an acid neutralizer or a base neutralized to the waste liquid by using one or more in-line venturis disposed in said recirculation line until the end pH of the waste liquid being treated is determined to be equal to or between the acceptable high and low reference pH values.

2. The method of claim 1, wherein the step (c) of determining the initial pH value for the waste liquid to be treated comprises sensing the pH of the waste liquid in said recirculation line as the waste liquid is being mixed in said treatment tank until a constant pH value is sensed.

3. The method of claim 1 wherein the step (e2) of adding either an acid neutralizer or a base neutralizer to the waste liquid is performed sequentially by adding incremental metered doses of either the acid neutralizer or the base neutralizer to the waste liquid in said recirculation line.

4. A batch process for pH neutralization of waste liquid, comprising:
(a) filling a treatment tank with waste liquid to be neutralized;
(b) determining an initial pH value for the waste liquid to be neutralized in said treatment tank by:
(b1) pumping the waste liquid to be neutralized from the treatment tank through a recirculation line and back to the treatment tank to mix the waste liquid to be neutralized in said treatment tank;
(b2) sensing the pH of the waste liquid as it flows through said recirculation line;
(b3) generating a sensed pH value indicative of the pH of the waste liquid flowing through said recirculation line; and
(b4) monitoring the sensed pH value of the waste liquid flowing through said recirculation line until said sensed pH value is a constant pH value which is indicative of the initial pH value for the waste liquid to be neutralized;
(c) comparing the initial pH value of the waste liquid in said recirculation line with high and low reference pH values, said reference pH values indicative of the highest and lowest acceptable pH values for the neutralized waste liquid after treatment; and
(d) after comparing the initial pH value of the waste liquid with the high and low reference pH values, performing one of the following actions:
(d1) stopping flow of waste liquid through said recirculation line and discharging the waste liquid from said treatment tank if the initial pH value of the waste liquid is equal to or between the high and low reference pH values; or
(d2) adding incremental metered doses of a base neutralizer to the waste liquid in said recirculation line if the initial pH value of the waste liquid is above the high reference pH value until the sensed pH value of the waste liquid flowing through said recirculation line is equal to or below the high reference pH value resulting in a pH neutralized waste liquid, and thereafter stopping waste liquid flow through said recirculation line and discharging the pH neutralized waste liquid from said treatment tank; or
(d3) adding incremental metered doses of an acid neutralizer to the waste liquid in said recirculation line if the initial pH value of the waste liquid is below the low reference pH value until the sensed pH value of the waste liquid flowing through said recirculation line is equal to or above the low reference pH value resulting in a pH neutralized waste liquid, and thereafter stopping waste liquid flow through said recirculation line and discharging the pH neutralized waste liquid from said treatment tank.

5. The batch process of claim 1 further including the steps of:
(e) sensing the level of neutralized waste liquid in said treatment tank;
(f) generating a low-level signal indicative of a low level of neutralized waste liquid in said treatment tank;
(g) stopping the discharge of neutralized waste liquid from said treatment tank in response to said low level signal; and
(h) repeating steps (a) through (d).

6. The batch process of claim 1 wherein the step (d2) of adding a base neutralizer to the waste liquid in said recirculation line comprises:
(d2i) pumping the waste liquid to be neutralized having said initial pH value through said recirculation line while also sensing the pH value of the waste liquid in said recirculation line;
(d2ii) injecting an incremental metered amount of base neutralizer to the waste liquid in said recirculation line until the sensed pH value of the waster liquid in said recirculation line decreases a desired amount;
(d2iii) after sensing a decrease in pH value, stop injecting the base neutralizer and continue pumping the waste liquid through said recirculation line and treatment tank until the sensed pH value in said recirculation line is once again a constant value; and
(d2iv) repeating steps (d2i), (d2ii) and (d2iii) until the sensed pH value of the waste liquid in said recirculation line is equal to or below the high reference pH value.

7. The batch process of claim 6, wherein the step (d2ii) of injecting an incremental metered amount of base neutralizer comprises creating a vacuum to draw the base neutralizer into said recirculation line.

8. The batch process of claim 7 wherein the step of creating a vacuum comprises incorporating an in-line venture in said recirculation line.

9. The batch process of claim 1 wherein the step (d3) of adding an acid neutralizer to the waste liquid in said recirculation line comprises:
(d3i) pumping the waste liquid to be neutralized having said initial pH value through said recirculation line while also sensing the pH value of the waste liquid in said recirculation line;
(d3ii) injecting an incremental metered amount of acid neutralizer to the waste liquid in said recirculation line until the sensed pH value of the waster liquid in said recirculation line increases a desired amount;
(d3iii) after sensing an increase in pH value, stop injecting the acid neutralizer and continue pumping the waste liquid through said recirculation line and treatment tank until the sensed pH value in said recirculation line is once again a constant value; and
(d3iv) repeating steps (d3i), (d3ii) and (d3iii) until the sensed pH value of the waste liquid in said recirculation line is equal to or above the low reference pH value.

10. The batch process of claim 9, wherein the step (d3ii) of injecting an incremental metered amount of acid neutralizer comprises creating a vacuum to draw the acid neutralizer into said recirculation line.

11. The batch process of claim 10 wherein the step of creating a vacuum comprises incorporating an in-line venture in said recirculation line.
